(19) United States
(12) Patent Application Publication
(10) Pub. No.: US 2012/0300910 A1
(43) Pub. Date: Nov. 29, 2012

(54) X-RAY IMAGING APPARATUS HAVING A VARIABLE DISTANCE BETWEEN AN X-RAY SOURCE AND AN OBJECT TO BE IMAGED

(76) Inventors: Sebastien Gorges, Versailles (FR); Vincent Bismuth, Paris (FR); Francois Kotian, Villepreux (FR); Yves Trousset, Palaiseau (FR)

(21) Appl. No.: 13/479,835

(22) Filed: May 24, 2012

(30) Foreign Application Priority Data
May 26, 2011 (EP) 11305641.0

(51) Int. Cl. H05G 1/02

(52) U.S. Cl. 378/198

(57) ABSTRACT

An X-ray imaging apparatus comprising a rotary arm and an image assembly mounted on the rotary arm is provided. The image assembly comprises an X-ray detector and an X-ray source configured to emit X-rays incidental to the X-ray detector, wherein the X-ray source is coupled to the rotary arm by a movable support configured to modify the position of the X-ray source to set the distance between the X-ray source and an object to be imaged, and wherein movement of the X-ray source is dynamically controlled during tri-dimensional imaging.

### BACKGROUND OF THE INVENTION

1. Field of the Invention

Embodiments of the present invention relate in general to medical imaging systems and, more particularly, to medical imaging systems for generating an image sequence for tri-dimensional (3D) image reconstruction.

2. Description of the Prior Art

X-ray imaging apparatuses for tri-dimensional (3D) image reconstruction usually comprise an imaging assembly having an X-ray source, usually an X-ray tube, and an X-ray detector placed opposite to the X-ray tube in the direction of emission of the X-rays. The tube and the detector are placed on two mutually opposite ends of a rotary arm.

The rotary arm is a C-shaped arm in the form of an arch.

During examination, radiographs are produced by means of X-rays emitted by the X-ray source which irradiate a region of interest (ROI) of the body of a patient.

For this purpose, after the patient has been laid out on an examination table, the X-ray tube and the detector are brought to face the area to be radiographed.

For 3D reconstruction, the C-arm is moved through an angle of 180° and an X-ray image is recorded for a set of angular positions of the imaging assembly.

A 3D reconstruction is widely used during neurological examinations like the so-called aneurysm coiling and arterioveinous malformation (AVM) treatment to have a 3D reconstruction of the patient anatomy.

A 3D reconstruction also may also be used with other procedures like abdominal procedures, in which the region of interest lies in the abdominal region.

In such a case, the rotational acquisition is difficult to perform since there is a high risk that either the X-ray source or the X-ray detector will knock against the examination table. As a matter of fact, basically, the tunnel formed during the rotational movement of the imaging assembly has a rayon of 60 cm centered at the isocenter of the imaging assembly.

In addition, with conventional C-arm imaging apparatuses, the tri-dimensional field of view is limited. As a matter of fact, with a C-arm imaging apparatus having a conventional design, in which the distance between the X-ray source and the object to be imaged is about 72 cm, a distance between the X-ray source and the X-ray detector is about 120 cm and a detector dimension is about 40 cm, the field of view of the imaging assembly is a cylinder having a diameter of about 20 cm, such that a significant region of an organ to be imaged may lie outside the area irradiated by the X-rays.

Several types of X-ray apparatuses have been developed to avoid the risks of having a collision between the imaging assembly and the examination table.

Some medical imaging systems avoid a table collision by dynamically modifying the isocenter position of the imaging assembly, usually formed by the rotation center of the rotary arm, during image acquisition.

In particular, positions of the X-ray detector are calculated to be tangential to an elliptical envelope surrounding the body of the patient, and a sequence of positions for the X-ray source is determined for each position of the X-ray detector.

In addition, selection can be made to determine whether a high resolution is desired or whether the largest possible volume of the region of interest is to be mapped to select a suitable position for the X-ray source.

However, with such imaging systems, it has been noted that the isocenter position of the imaging assembly is not fixed, such that the tri-dimensional region projected into the image plane is not constant. In other words, the portion of the organ imaged during the 3D reconstruction is a function of the C-arm position, degrading the image quality of the reconstructed 3D image.

In view of the foregoing, there is a need to have a tri-dimensional X-ray imaging apparatus capable of avoiding the risk that the X-ray source or the X-ray detector will knock against the examination table, while avoiding artefacts in the reconstructed tri-dimensional means.

There is also a need to have a tri-dimensional X-ray imaging apparatus that permits dynamic movement of the X-ray source to avoid a table collision, while keeping the isocenter of the imaging assembly fixed.

### BRIEF SUMMARY OF THE INVENTION

According to an embodiment of the present invention, there is provided an X-ray imaging apparatus comprising a rotary arm and an image assembly mounted on the rotary arm is provided. The image assembly comprises an X-ray detector and an X-ray source configured to emit X-rays incidental to the X-ray detector, wherein the X-ray source is coupled to the rotary arm by a movable support configured to modify the position of the X-ray source to set the distance between the X-ray source and an object to be imaged, and wherein movement of the X-ray source is dynamically controlled during tri-dimensional imaging.

According to an embodiment of the present invention, there is provided a method for operating an X-ray imaging apparatus comprising a rotary arm and an imaging assembly mounted on the rotary arm, wherein the imaging assembly comprises a X-ray detector and a X-ray source coupled to the rotary arm by a movable support. The method comprises modifying the position of the X-ray source to set the distance between the X-ray source and an object to be imaged and dynamically controlling movement of the X-ray source during tri-dimensional imaging.

### BRIEF DESCRIPTION OF THE DRAWINGS

Features and advantages of embodiments of the present invention will become apparent on reading the detailed description below with reference to the drawings, which are illustrative but non-limiting, wherein:

FIG. 1 is a perspective view of an X-ray imaging apparatus according to an embodiment of the present invention;

FIG. 2 is a schematic view showing the path of the X-ray source during image acquisition according to an embodiment of the present invention; and

FIG. 3 is a schematic view of the X-ray imaging apparatus showing the steps of adjusting the source to object distance (SOD) according to an embodiment of the present invention.

### DETAILED DESCRIPTION OF THE INVENTION

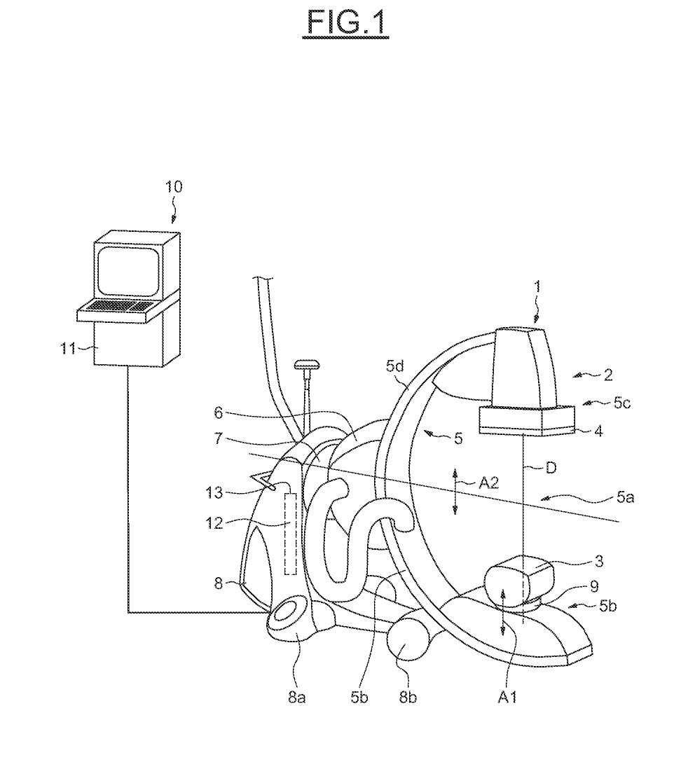

Reference is first made to FIG. 1, illustrating a perspective view of an X-ray imaging apparatus 1 for 3D medical imaging according to an embodiment of the present invention.

This imaging apparatus 1 is in particular intended to generate an image sequence for a tri-dimensional reconstruction of an object to be studied, for example, a part of the patient body. In one exemplary but non-limiting application of the present invention, the object to be viewed is a region of interest of an abdominal organ.

As it can be seen, the imaging apparatus 1 includes an imaging assembly 2 operable to generate medical images of a human object lying on an examination table (not shown in FIG. 1).

The imaging assembly 2 may include any suitable imaging means. In the illustrated embodiment, the imaging assembly 2 comprises an X-ray source, namely an X-ray tube 3, operable to generate X-rays in an emission direction and an X-ray detector 4 operable to generate a medical image of the subject.

The X-ray tube 3 and the X-ray detector 4 are placed at two mutually opposite ends of an arm 5, namely a C-arm supporting the imaging assembly 2, such that the X-rays emitted by the X-ray tube 3 are incidental to the X-ray detector 4.

As seen, the C-arm 5 has a front opening 5a for accommodating the subject being imaged, a lower distal end 5b supporting the X-ray tube 3, an upper distal end 5c supporting an X-ray detector 4 and a curved back segment 5d having the arch shape.

The C-arm 5 is slidingly mounted on a capture unit 6 coupled in a rotatable relation to an arm 7 by a rotation knuckle (not shown). The arm 7 is mounted on a movable base assembly 8.

Therefore, the arm 7, the capture unit 6 and the C-arm 5 are all articulated relative to one another about articulation axes, so that the imaging apparatus 1 can be moved in three dimensions, and thus, take images of an organ to be examined at various angles of incidence.

In one embodiment, the base assembly 8 constitutes a mobile device provided with a running system comprising, for example, two lateral drives and steering wheels 8a placed at the rear, two free front wheels 8b, and means for driving the drive wheels comprising a steering motor coupled to a drive motor. The base assembly 8 can thus be a robotized programmable device and may be associated with a navigation system capable, for example, of communicating by radio electric links with identification devices (not shown) placed in the operating room in order to allow the imaging apparatus 1 to locate itself precisely in the room and, in particular, relative to the examination table T.

During radiography, the X-ray tube 3 and the X-ray detector 4 are brought to face a region of interest (ROI) in the body of a patient laid out on the examination table T so that, when the region of interest is interposed between the X-ray tube 3 and the X-ray detector 4, the ROI is irradiated by the X-rays, and the X-ray detector 4 produces representative data of features of the interposed region of interest.

In addition, during examination, the C-arm 5 supporting the X-ray tube 3 and the X-ray detector 4 is moved along an acquisition path through an angle of 180° around a rotation center to obtain X-ray images for different angular positions of the imaging assembly 2 such that a 3D reconstruction can be achieved.

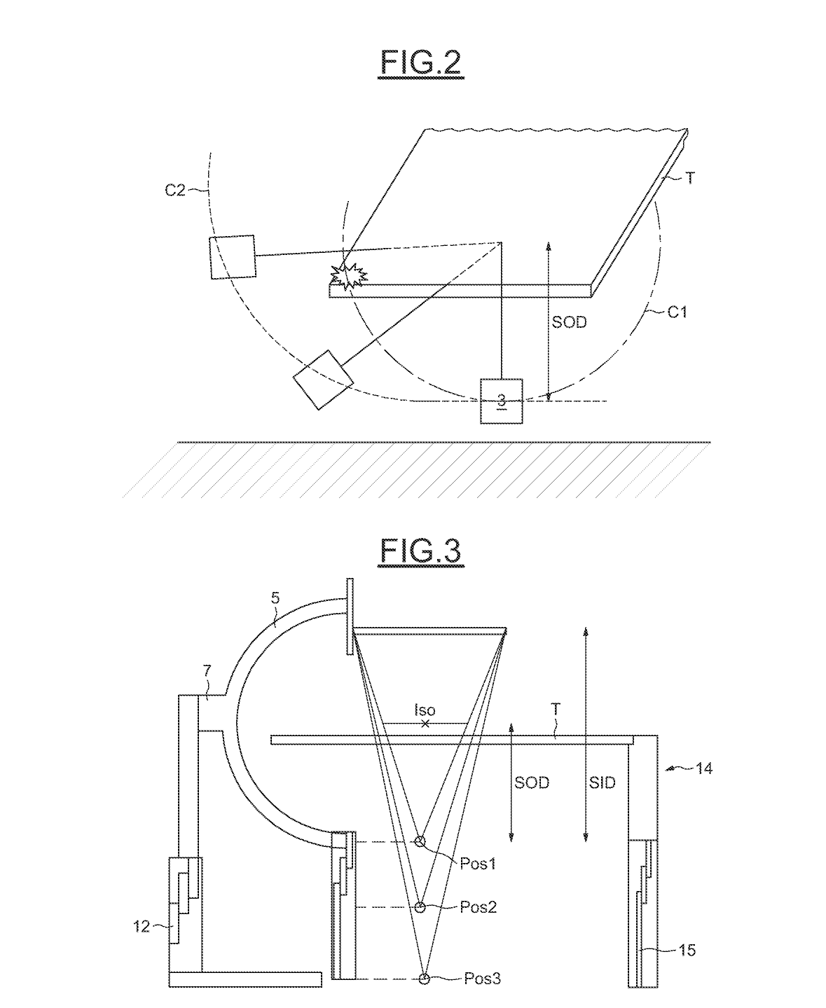

According to an embodiment of the present invention as illustrated in FIG. 2, the X-ray tube 3 is mounted on the lower distal end 5b of the C-arm 5 by a movable support 9 such that the X-ray tube 3 can be extended or retracted along the X-ray emission direction D (arrow A1).

In conventional X-ray imaging apparatuses, the X-ray tube 3 is moved along a circular path C1, such that, during a tri-dimensional image acquisition, the X-ray tube 3 may knock against the examination table T. However, according to an embodiment of the present invention, the movable support 9 is operable to increase the distance SOD between the X-ray tube 3 and the object to be imaged before the X-ray tube 3 reaches the plane of the examination table T to avoid collision therewith.

In other words, the movable support 9 is thus operable to move the X-ray tube 3 along a non-circular trajectory C2.

The movable support 9 is coupled between the lower distal end 5b and the X-ray tube 3. The movable support 9 supports the X-ray tube 3 and extends and retracts the X-ray tube 3 according to the angular position of the C-arm 5. The movable support 9 can include different arrangements and may comprise a telescopic support, for example, a lift column, having one end embedded within the lower distal end 5b of the C-arm 5 and an opposite end supporting the X-ray tube 3.

As further illustrated in FIG. 1, the X-ray imaging apparatus 1 is further provided with a central processing unit 10, schematically represented, that is provided with a control console 11, and is duly programed to control the movement of the imaging assembly 2 depending on the phases of an examination to be carried out.

In particular, the central processing unit 10 is furnished with storage means, of data storage memory type, for example of the ROM, RAM, etc. . . . type, incorporating one or more control algorithms capable of moving the movable base assembly 8 and the imaging assembly 2 relating to the base assembly 8, particularly the rotation of the C-arm 5 as well as the movement of the movable support 9, either automatically, or under the control of the control console 10, in response to instructions entered manually by an operator.

However, as concerns extending and retracting the X-ray tube 3 from the lower distal end 5b of the C-arm 5, this movement is controlled automatically as a function of the rotational angle of the C-arm 5. Information concerning the pivot angle of the C-arm 5 may be obtained by different means, for example, by using sensors.

The movable support 9 used to set the distance between the X-ray tube 3 and the object to be imaged avoids tube collision when a tri-dimensional image acquisition is performed, particularly on an abdominal structure. In addition it is possible to center the region of interest of an organ to be examined and acquire full reconstruction of the organ.

Centering the region of interest of the organ on the isocenter of the imaging assembly thus permits full reconstruction of the organ.

According to an embodiment, the X-ray image apparatus 1 is further provided with a second movable support 12 embedded within the base assembly 8.

This second movable support 12 is also controlled by the central processing unit 10 and is operable to extend and retracting the imaging assembly 2 from the base assembly 8 (Arrow A2).

The second movable support 12 can also be of different constructions. For example, in one embodiment, the second movable support 12 comprises a lift column 15 extending in the vertical direction within the base assembly 8 and having an upper end 13 coupled to the arm 7 supporting the C-arm 5.

Referring to FIG. 3, the examination table T is mounted on a support 14 having a variable height and provided with a lift column 15. The lift column 15 is also operable and controlled by the control processing unit 10 to set the height of the examination table T according to the on-going phase of an examination to be carried out.

Particularly, the distance SOD between the X-ray tube 3 and the object to be imaged, and the distance SID between the X-ray tube 3 and the X-ray detector 4 are adjusted for the 3D image acquisition.

Specifically, to have the maximum X-ray tube 3 to X-ray detector 4 distance SID, and consequently to have an increased tri-dimensional region of interest, before 3D image acquisition, the second movable support 12 is operated to lift the C-arm 5 and the imaging assembly 2 supported thereby, and to lower the X-ray tube 3 from position Pos1 to position Pos3. This movement increases the distance SOD between the X-ray tube 3 and the object to be imaged.

The lift column 15 of the table support 14 is then operated to adjust the examination table T height such that the object to be imaged reaches the isocenter position Iso. The risks of collision between the imaging assembly 2 and the examination table T are thus avoided, and the size of the reconstructed 3D region of interest is improved.

In one embodiment, the above steps of operation are carried out automatically under the control of the control processing unit 10.

In one embodiment, for different positions Pos1, Pos2, and Pos3 of the X-ray tube 3, the following SOD and SID distances and the following sizes for the region of interest ROI can be obtained:
Position Pos1 (without lift for the X-ray tube 3):
   SID=120 cm
   SOD=72 cm
   SID/SOD=1,6
   ROI=25 cm
Position Pos2 (with a lift of 50 cm for the X-ray tube 3):
   SID=170 cm
   SOD=122 cm
   SID/SOD=1,39
   ROI=28 cm
Position Pos3 (with a lift of 100 cm for the X-ray tube 3):
   SID=220 cm
   SOD=172 cm
   SID/SOD=1,27
   ROI=31 cm.

Accordingly, embodiments of the present invention provide a tri-dimensional X-ray imaging apparatus that permits dynamic movement of the X-ray source to avoid a table collision, while keeping the isocenter of the imaging assembly fixed.

What is claimed is:

1. An X-ray imaging apparatus comprising:
a rotary arm; and
an image assembly mounted on the rotary arm, the image assembly comprising:
an X-ray detector; and
an X-ray source configured to emit X-rays incidental to the X-ray detector,
wherein the X-ray source is coupled to the rotary arm by a movable support configured to modify the position of the X-ray source to set the distance between the X-ray source and an object to be imaged, and
wherein movement of the X-ray source is dynamically controlled during tri-dimensional imaging.

2. The X-ray imaging apparatus according to claim 1, wherein the movable support is configured to move the X-ray source along an X-ray emission direction.

3. The X-ray imaging apparatus according to claim 1, wherein the movable support comprises a telescopic support.

4. The X-ray imaging apparatus according to claim 1, further comprising a controller configured to dynamically control movement of the X-ray source during tri-dimensional imaging as a function of a rotation of the rotary arm.

5. The X-ray imaging apparatus according to claim 1, wherein the rotary arm is coupled to a base assembly through a second movable support configured to extend and to retract the imaging assembly from the base assembly.

6. The X-ray imaging apparatus according to claim 1, further comprising an examination table configured to have a variable height.

7. A method for operating an X-ray imaging apparatus comprising a rotary arm and an imaging assembly mounted on the rotary arm, wherein the imaging assembly comprises a X-ray detector and a X-ray source coupled to the rotary arm by a movable support, the method comprising:
modifying the position of the X-ray source to set the distance between the X-ray source and an object to be imaged; and
dynamically controlling movement of the X-ray source during tri-dimensional imaging.

8. The method according to claim 7, wherein the rotary arm is coupled to a base assembly by a second movable support, the method further comprising:
extending and retracting the imaging assembly from the base assembly with the second movable support.

9. The method according to claim 7, further comprising:
adjusting a distance between the X-ray source and the object to be imaged and a distance between the X-ray source and the X-ray detector before image acquisition.

10. The method according to claim 9, further comprising:
lifting the rotary arm to extend the imaging assembly from the base assembly;
increasing the distance between the X-ray source and the object to be imaged; and
adjusting the position of an examination table according to an isocenter position of the imaging assembly.

11. The method according to claim 9, further comprising:
automatically lifting the rotary arm to extend the imaging assembly from the base assembly;
automatically increasing the distance between the X-ray source and the object to be imaged; and
automatically adjusting the position of an examination table according to an isocenter position of the imaging assembly.
